(19) United States
(12) Patent Application Publication
(10) Pub. No.: US 2011/0033219 A1
(43) Pub. Date: Feb. 10, 2011

(54) DEVICE FOR PACKAGING A COSMETIC ARTICLE

(75) Inventor: Rodolphe DA ROVARE, Genevilliers (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/821,411

(22) Filed: Jun. 23, 2010

Related U.S. Application Data
(60) Provisional application No. 61/225,639, filed on Jul. 15, 2009.

(30) Foreign Application Priority Data
Jun. 24, 2009 (FR) 0954315

(51) Int. Cl. B43K 21/02

(52) U.S. Cl. 401/55

(57) ABSTRACT

A device for packaging a cosmetic article includes a casing which defines a housing for the cosmetic article which is rotationally movable between a position retracted in the housing and a deployed position and a mechanism for automatically urging the sheath of the cosmetic article from the retracted position to the deployed position thereof. The device also includes a member for actuating the urging mechanism which are mounted on a return mechanism, the return mechanism being separate from the urging mechanism.

The present invention relates to a packaging device, of the type comprising:
a cosmetic article;
a casing which defines a housing between two opposing surfaces, the cosmetic article being rotationally movable between a position retracted in the housing in which the cosmetic article is interposed between the two opposing surfaces, and a position deployed outside the housing, and
means for automatically urging the cosmetic article from the retracted position to the deployed position thereof.

The term “cosmetic article” in the context of the present invention is intended in particular to refer to an assembly containing a cosmetic product which is intended to be applied to a human being in the form of a solid, such as a powder, a liquid or a cream. This product is, for example, in the form of a self-supporting product, which has inherent mechanical strength, such as a baton or a block.

A “cosmetic product” is more generally a product as advantageously defined in the EC Council Directive 93/35 of 14 Jun. 1993.

The term “cosmetic article” is also intended to refer to a tool which is used indirectly or directly to apply a cosmetic product, such as an applicator of the type brush, paint brush, powder puff, flocked member or sponge, or such as a mirror or a nail file. There is known, for example, from DE 62 0193, a packaging and application device of the above-mentioned type which comprises a casing which comprises a body which is generally of general parallelepipedal form and which is provided, on one of the lateral faces thereof, with an opening which allows a sheath to be pivoted between a position retracted in a housing which is provided in the body of the casing and a protruding position for application of the cosmetic product.

To this end, the sheath is mounted, at one of the ends thereof, on a shaft which is associated with a spring which allows the sheath to pivot following actuation of a button and allows the sheath to be fixed in the retracted position.

Such a mechanism is not entirely satisfactory. There may be phenomena of pinching of the sheath when it pivots or poor blocking of the sheath inside the casing owing to the combination of the two functions by the spring which must act as a torsion spring and as a compression spring.

An object of the invention is to provide a device for packaging a cosmetic article which avoids this type of disadvantage.

To this end, the invention relates to a packaging device of the above-mentioned type, characterised in that the device comprises:
a member for actuating the urging means, which can be moved between a position for retaining the cosmetic article in the housing and a position for releasing the cosmetic article;
means for returning the actuation member towards the retention position thereof, the return means being separate from the urging means.

According to a specific embodiment, it comprises one or more of the following features:
the casing is formed by a body which comprises a lateral opening for the passage of the cosmetic article between the two positions;
the cosmetic article is mounted on a pivoting support which is mounted so as to rotate freely on the actuation member inside the housing of the casing;
the actuation member can be moved in translation relative to the casing along a movement axis between the retention position and the release position;
the movement axis is parallel with or common with the rotation axis of the cosmetic article;
the actuation member comprises a pushing rod which extends through the support, the pushing rod comprising a first end which opens outside the casing and a second end which is connected to the return means;
the return means are formed by a resiliently deformable portion which is provided in a plate which abuts against an inner wall of the housing of the casing;
the return means comprise a resilient urging member, advantageously a spring or a resilient lug, which is interposed between the actuation member and a surface of the casing;
the return means are integral with one of the actuation member or the casing;
the urging means comprise a torsion spring which comprises a first end which is connected to the casing and a second end which is connected to the cosmetic article;
the cosmetic article comprises a sheath which contains a self-supporting product in the form of a baton or block, the self-supporting product being movably mounted in the sheath;
one of the sheath or the casing comprises a mechanism for axial deployment of the self-supporting product out of the sheath in the deployed position of the sheath;
the cosmetic article comprises a support which contains a cosmetic product or which carries a tool for assisting the application of a cosmetic product;
the device comprises releasable means for retaining the cosmetic article in the retracted position thereof counter to the urging means, the movement of the actuation member between the retention position and the release position bringing about the release of the releasable retention means; and
a base of the housing of the casing comprises a sealing element which is capable of co-operating with the cosmetic article in the retracted position thereof.

The invention will be better understood from a reading of the following description, given purely by way of example and with reference to the appended drawings, in which:

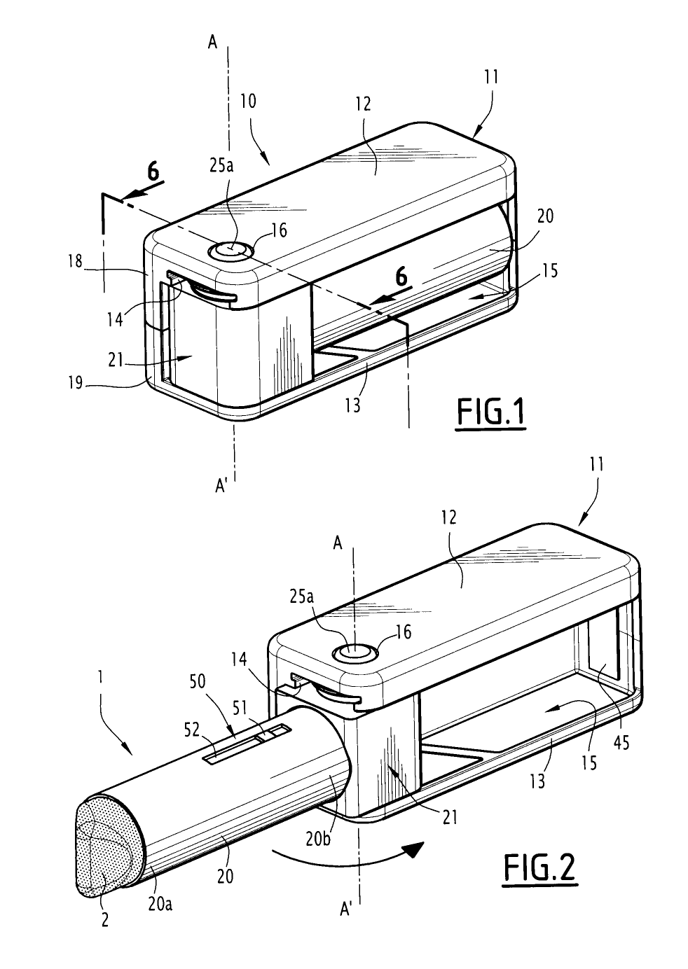

FIG. 1 is a perspective view of a packaging and application device according to the invention, with the cosmetic product in the form of a baton in the retracted position,

FIG. 2 is a perspective view of the packaging and application device according to the invention, with the cosmetic product in the form of a baton in the deployed position for use,

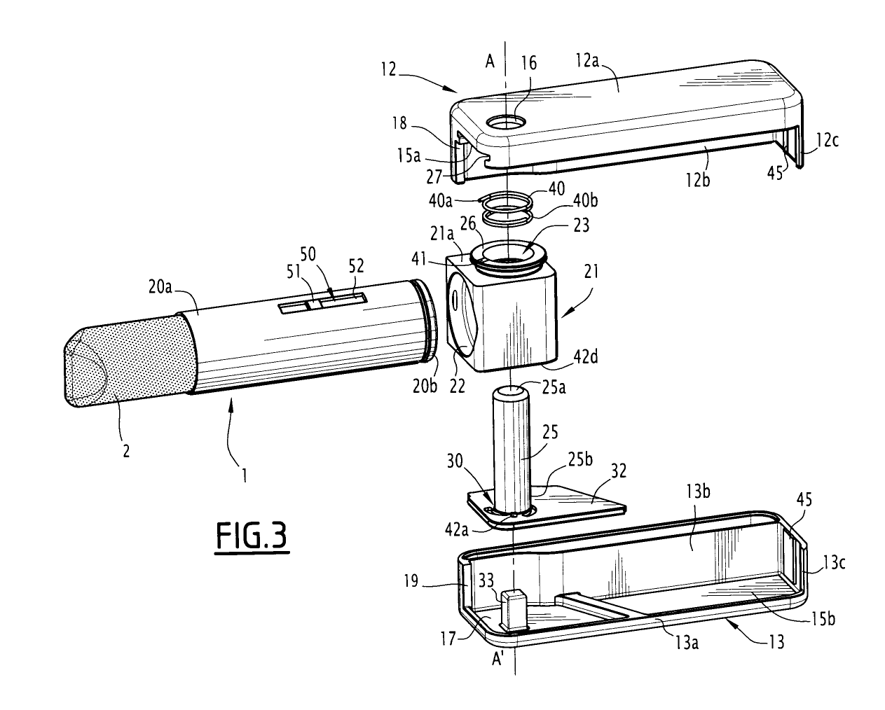

FIG. 3 is an exploded perspective view of the device according to the invention,

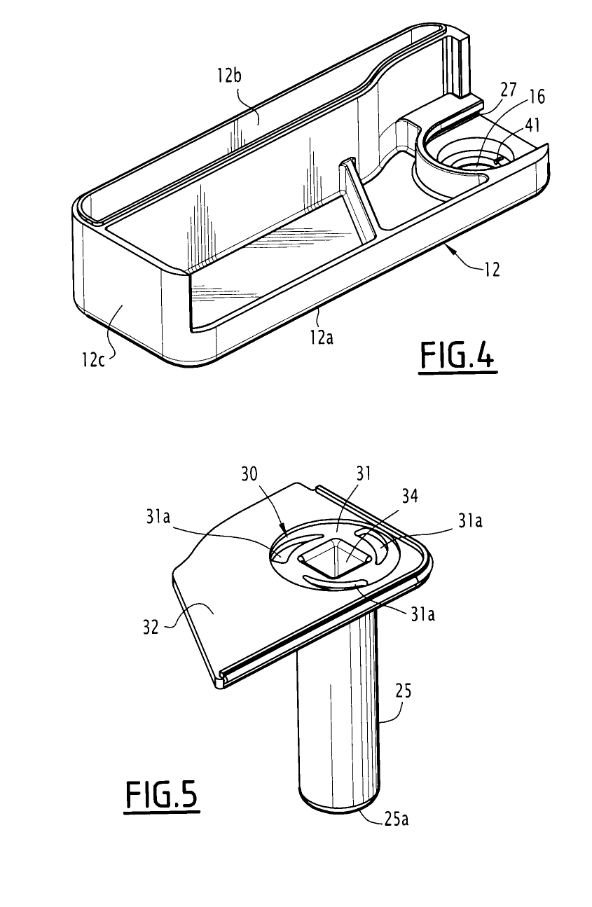

FIG. 4 is a perspective view of the inner side of the upper half-shell of the casing,

FIG. 5 is a perspective view of the pushing rod of the member for actuating the sheath from the retracted position to the deployed position thereof,

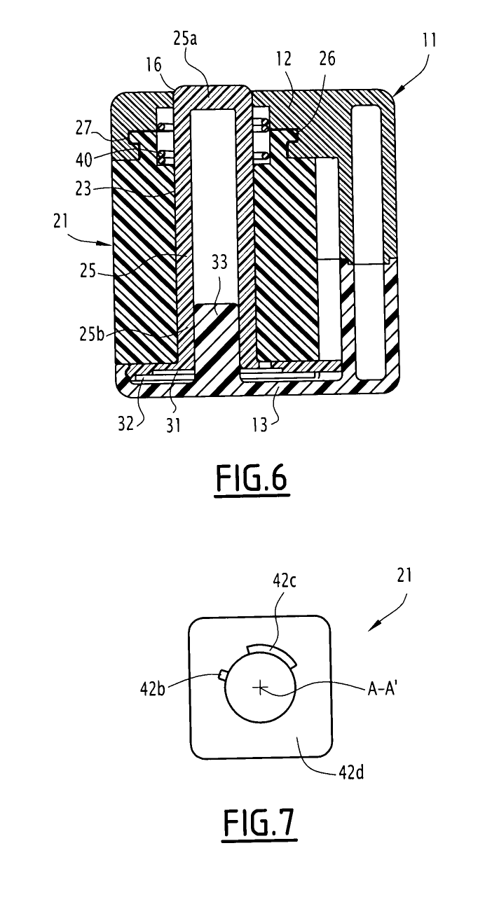

FIG. 6 is a sectioned view along line 6-6 of FIG. 1,

FIG. 7 is a schematic bottom view of the support of the cosmetic product,

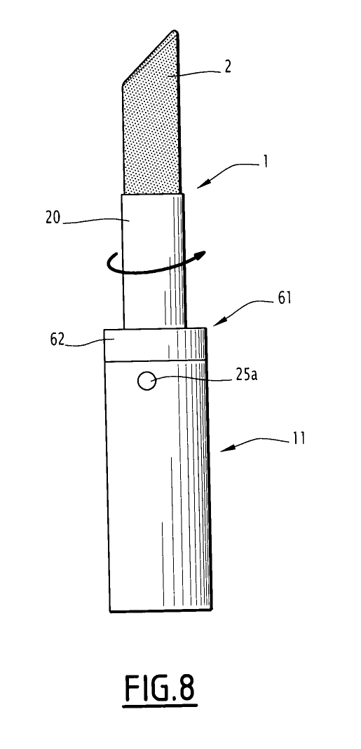

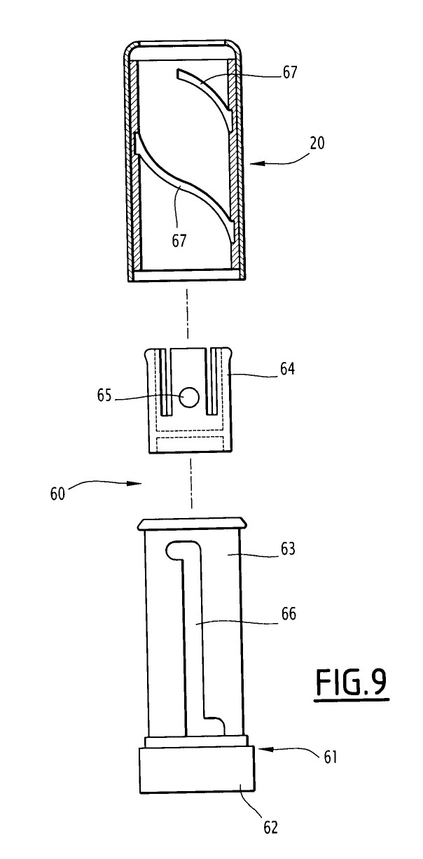

FIGS. 8 and 9 are a front view and an axial section of a variant of the mechanism for moving the cosmetic product in the form of a baton, respectively, and

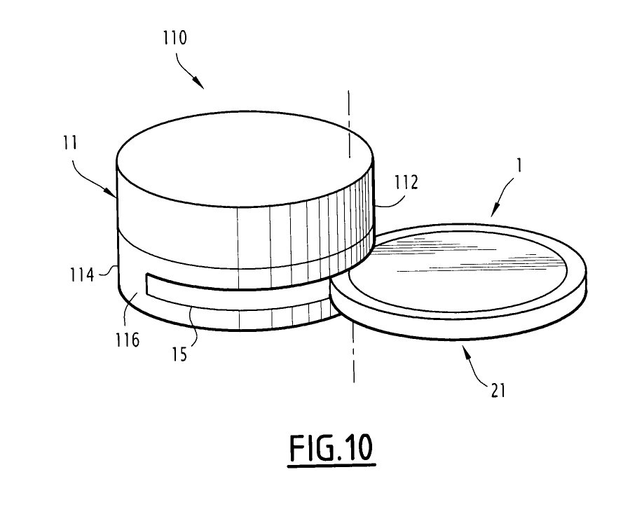

FIG. 10 is a three-quarter front perspective view of a second device according to the invention.

In the embodiment illustrated in the Figures, the packaging device which is generally designated 10 is intended for the application of a cosmetic article 1 which is formed by a product in the form of a baton 2, of the type which constitutes a stick, in particular a lipstick.

More generally, the cosmetic article 1 comprises a cosmetic or care formulation, a product applicator, such as a brush, a powder puff, a foam, a flocked member, a paint brush, etc., or a cosmetic tool, such as a mirror which is intended to assist the application of a product to the face or a nail file or the like. The formulation may comprise a self-supporting product comprising a baton or block of product 2. The product may be in the form of a stick or in compacted form. This product may be, for example, a lipstick, a foundation, an eye shadow, a blusher, etcetera.

The device 10 comprises a casing 11 which is formed by two half-shells, an upper half-shell 12 and a lower half-shell 13, respectively.

As illustrated in FIG. 3, the half-shell 12 comprises an upper wall 12a, a lateral wall 12b and a base wall 12c. In the same manner, the half-shell 13 comprises a lower wall 13a, a lateral wall 13b and a base wall 13c.

The two half-shells 12 and 13 are superimposed, as illustrated in FIGS. 1 and 2, in order to constitute a body which, in the embodiment in the Figures, has a generally rectangular parallelepipedal shape.

As will be seen below, this body may have other shapes which are adapted to the shape and the dimensions of the cosmetic article 1 which it contains.

When the two half-shells 12 and 13 are assembled and fixed together, for example, by means of adhesive-bonding, they provide, as illustrated in FIGS. 1 and 2, a front opening 14 and a lateral opening 15 which delimit a housing 15c for receiving the cosmetic article. The housing is defined between two opposing surfaces 15a, 15b which are located on the upper wall 12a and the lower wall 13a, respectively.

The baton product 2 is movably mounted in a tubular sheath 20 which comprises a front end 20a which is open for passage of the product 2 and a closed rear end 20b.

The sheath 20 is fixed to a support 21 which, in the embodiment illustrated in the Figures, is in the form of a cube. The rear end 20b of the sheath 20 is mounted, for example, by means of snap-fitting in an opening 22 which is provided in the support 21 in a removable manner in order to be able to remove the sheath 20 when the baton product 2 has been consumed.

According to a variant which is not illustrated, the support 21 can be overmoulded on the sheath 20.

The sheath 20 and the baton product 2 which is contained in the sheath 20 which forms the cosmetic article 1 can be moved in rotation about an axis A-A′ between a position retracted in the housing 15c (FIG. 1) and a deployed position for use of the baton-like product 2 (FIG. 2).

Generally, the device 10 comprises:
means for automatically urging the cosmetic article 1 from the retracted position to the deployed position thereof, and
a member for actuating the urging means which are mounted on return means, the return means being separate from the urging means,
releasable means for retaining the cosmetic article 1 in the retracted position thereof counter to the urging means.

As illustrated in FIG. 3, the support 21 comprises a vertical axial passage 23 for the actuation member formed by a pushing rod 25.

The support 21 is mounted so as to rotate freely about an axis of rotation A-A′ on the pushing rod 25 in order to pivot between the two positions of the sheath 20.

The support 21 comprises on the upper wall 21a thereof a circular collar 26 which is intended to co-operate with a groove 27 which is provided on the inner face of the upper wall 12a of the half-shell 12. As illustrated in FIG. 4, the groove 27 is U-shaped in order to allow the circular collar 26 to fit inside and thus rotationally guide the support 21 during the pivoting of the sheath 20 between the position retracted in the housing 15c and the deployed position.

As illustrated in FIG. 6, the pushing rod 25 extends through the support 21 via the axial passage 23 and comprises a first end 25a which opens outside the casing 11 via a hole 16 which is provided on the upper wall 12a of the half-shell 12. The pushing rod 25 comprises a second end 25b which is connected to the return means which are generally designated 30.

These return means 30 illustrated in FIG. 5 are formed by a resiliently deformable portion 31 which is provided in an abutment plate 32 which is placed in an indentation 17 (FIG. 3) which has a shape which complements the plate 32. The indentation 17 is provided on the inner face of the lower wall 13a of the half-shell 13.

The portion 31 comprises, as illustrated in FIG. 5, notches 31a, for example, three of them, in order to confer yet more resilience to this portion 31.

The pushing rod 25 can be moved in translation along the axis A-A′ counter to the return means 30 between a position for retaining the cosmetic article in the housing, in which the end 25a of the pushing rod 25 protrudes away from the half-shell 12 and an indented position for releasing the cosmetic article, in which the end 25a has been moved towards the housing.

A nipple 33, for example having a square cross-section (FIG. 3) is provided on the inner face of the lower wall 13a of the half-shell 13 and this nipple 33 is intended to co-operate with a hole 34 (FIG. 5) which is provided in the pushing rod 25 in order to ensure the guiding of this pushing rod when it is moved in translation, as will be seen below. The hole 34 has a cross-section which complements the cross-section of the nipple 33.

In the example illustrated in FIG. 6, the nipple 33 is integral with the half-shell 13. In a variant, the nipple 33 is fitted in an optionally blind hole of the half-shell 13.

As illustrated in FIG. 3, the urging means comprise a torsion spring 40 which surrounds the pushing rod 25. A first end 40a of the spring 40 is engaged in a notch 41 which is provided on the edge of the hole 16 of the half-shell 12 (FIG. 4) and the other end 40b is also engaged in a notch, not illustrated, which is provided in the hole 23 of the collar 26 of the support 21.

The releasable retention means comprise a protrusion 42a which is fixedly joined to the abutment plate 32. As can be seen in FIG. 7, the retention means further comprise a hole 42b for retaining the protrusion 42a and an actuation ramp 42c which are provided in a lower surface 42d of the support 21 which is located opposite the plate 32. In a variant, the protrusion 42a is fixedly joined to the support 21, the hole 42b and the ramp 42c being provided in the plate 32.

The protrusion 42a is formed by a pin which protrudes towards the support 21 from the plate 32. The protrusion 42a extends, for example, between two notches 31a in the resiliently deformable portion of the plate 32.

The hole 42b is provided in the surface 42d at the periphery of the axial passage 23. It has an angular extent about the axis A-A′ which is substantially equal to the angular extent of the protrusion 42a about this axis.

The ramp 42c is provided in the surface 42d at the periphery of the axial passage 23, angularly remote from the hole 42b. It has a height which increases during angular movement towards the hole 42b.

In the retracted position of the cosmetic article 1, the protrusion 42a can be moved between a position inserted in the hole 42b in which the article 1 is retained angularly relative to the casing 11 and a position removed from the hole 42b under the action of the deformation of the support plate 32.

The base walls 12c and 13c of the housing 15c of the casing 11 comprise internally a sealing element 45, such as, for example, a lip of flexible material, which is capable of co-operating with the free end 20a of the sheath 20 in the retracted position thereof.

The width of the sealing element 45, taken vertically in FIG. 2, is greater than the diameter of the sheath 20 at the free end 20a thereof.

As can be seen in FIGS. 2 and 3, the sheath 20 comprises a mechanism for axial movement of the cosmetic product 1 in the deployed position of this sheath 20.

According to a first embodiment illustrated in FIGS. 2 and 3, the movement mechanism 50 comprises a sliding member 51 which slides in a groove 52 which is provided in the sheath 20 in continuation of the first end 25a of the pushing rod 25. The sliding member 51 is connected, for example, to a piston (not illustrated) which is arranged in the sheath and which acts on the baton-like cosmetic product 1.

According to a variant which is not illustrated, the axial movement mechanism of the cosmetic product 1 can be arranged on the casing 11. Also in this instance, the movement mechanism comprises a sliding member which slides in a groove which is provided in the body 11 of the casing 11 in continuation of the first end 25a of the pushing rod 25.

Initially, outside the periods of use, the sheath 20 which contains the baton product 2 is in a position retracted in the housing 15c of the casing 10, as illustrated in FIG. 1. In this position, the element 45 ensures the sealing of the free end 20a of the sheath 20. In the position in which the support 21 and the sheath 20 are retracted inside the housing 15c, this support 21 and this sheath 20 are retained by the retention means. To this end, the protrusion 42a is inserted in the hole 42b and prevents rotation about the axis A-A′ of the support 21 and the cosmetic article 1 relative to the casing 11, counter to the force produced by the spring 40 of the urging means.

In this retracted position, the cosmetic article 1 and the support 21 thereof are therefore interposed or arranged in a sandwich-like manner between the two surfaces 15a, 15b defined by the casing 11.

In order to use the cosmetic product 1, the user presses with his thumb on the end 25a of the pushing rod 25 which protrudes above the upper wall 12a of the body of the casing 11, which has the effect of pushing this rod 25 and the flexible portion 31 along the axis A-A′ towards the interior of the housing. The pushing rod 25 therefore moves perpendicularly relative to the longitudinal axis of the casing 10.

During this movement, the protrusion 42a also moves parallel to the axis A-A′ and moves out of the hole 42b.

In this manner, the support 21 and the cosmetic article 1 are released in terms of rotation about the axis A-A′. Under the action of the spring 40, they pivot towards the deployed position, as illustrated in FIG. 2.

In the deployed position, the support 21 and the sheath 20 are retained by means of shoulders 18 and 19 which are provided on two half-shells 12 and 13 in the region of the lateral edge of the front opening 14.

Then, the user only has to move his thumb from the end 25a of the pushing rod 25 on the sliding member 51 and to slide the sliding member 51 in the groove 52 in order to remove the baton-like cosmetic product 1 from the sheath 20.

After use, the user returns the baton-like cosmetic product 1 into the sheath 20 by returning the sliding member 51 into its initial position.

Then, he withdraws the sheath 20 into the housing 15c of the casing 10 by pivoting this sheath 20 and the support 21 about the pushing rod 25. During this movement, the protrusion 42a is placed angularly opposite the ramp 42c and co-operates with the ramp 42c in order to bring about an increasing deformation of the flexible portion 31. Furthermore, this co-operation brings about friction during the movement of the support 21 and the accessory 1 which gives an impression of strength to the touch.

Then, when the accessory 1 reaches the retracted position, the protrusion 42a once again enters the hole 42b. The flexible portion 31 again blocks the support 21 and the sheath 20 in the retracted position.

According to another embodiment illustrated in FIGS. 8 and 9, the sheath 20 comprises a mechanism 60 for axial movement of the baton product 2 in the deployed position of the sheath 20 by rotating a control member 61.

The control member 61 is formed by a base 62 which is extended by a tube 63 inside which there is mounted a cup 64 which supports the baton product 2.

The tube 63 of the control member 61 and the cup 64 are placed inside the sheath 20. The sheath 20 is in abutment against the base 62 and this assembly is mounted on the support 21.

The cup 64 comprises two diametrically opposed studs 65 which are arranged so as to slide in two diametrically opposed guiding slots 66 of the tube 63.

The ends of the studs 65 move into engagement in helical grooves 67 so that a rotation movement of the control member 61 relative to the sheath 20 is accompanied by an axial movement of the cup 64 and the baton product 2.

In a variant, the return means 30 comprise, in place of the plate 32, a resilient urging member which is advantageously a spring or a resilient lug and which is interposed between the actuation member 25 and a surface of the casing 11.

The resilient urging member is, for example, integral with one of the actuation member 25 or the casing 11 or is fitted between the actuation member and the surface of the casing 11.

A second packaging device 110 according to the invention is illustrated in FIG. 10. In contrast to the first device 10, the casing 11 has a general shape which exhibits symmetry of revolution about an axis. In this example, the casing 11 is formed by a substantially cylindrical body.

This body comprises an upper portion 112 in the form of a shell which is closed by a removable cover and which internally delimits a compartment for receiving a cosmetic product.

The body further comprises a lower portion 114 which is also in the form of a shell and which delimits the housing for receiving the cosmetic article 1.

The housing is defined between two opposing horizontal surfaces of the body. It opens via the lateral opening 15 in the form of a slice which is provided in the lateral surface 116 of the lower portion.

The cosmetic article 1 is received on a support 21 which is formed by a rotating cup container 118. In the example illustrated in FIG. 10, the article 1 comprises a mirror which is used to apply the product contained in the upper portion 112 or/and an applicator.

As for the first device 10, the cosmetic article 1 and the support 21 of the second device 110 can be moved in rotation about an axis A-A′ perpendicular relative to the general plane of the lateral opening 15 between a position retracted in the housing 15c in which the cosmetic article is interposed between the two opposing horizontal surfaces, and a position deployed outside the housing 15c.

The mechanism for deployment of the cosmetic article 1 and the support thereof is further similar to that of the first device 10 with the difference that the end 25a for actuating the deployment of the cosmetic article located on the actuation member is advantageously arranged below the body.

Regarding the first device 10 and the second device 110, the fact that the support 21 is “free to rotate about an axis A-A′ on the pushing rod 25” means that, once the retention means have been released, there is no obstacle to the rotation of the support 21 between the two positions of the sheath 20.

1. A packaging device comprising:
a cosmetic article;
a casing which defines a housing between two opposing surfaces, the cosmetic article being rotationally movable between a position retracted in the housing in which the cosmetic article is interposed between the two opposing surfaces, and a position deployed outside the housing, and
means for automatically urging the cosmetic article from the retracted position to the deployed position thereof,
an actuation member for actuating the means for urging, said member being movable between a retention position for retaining the cosmetic article in the housing and a release position for releasing the cosmetic article;
means for returning the actuation member towards the retention position thereof, the return means being separate from the urging means;
wherein the cosmetic article is mounted on a pivoting support, the support being mounted so as to rotate freely on the actuation member inside the housing of the casing.

2. A device according to claim 1, wherein the casing is formed by a body which comprises a lateral opening for the passage of the cosmetic article between the two positions.

3. A device according to claim 1, wherein the actuation member is movable in translation relative to the casing along a movement axis between the retention position and the release position.

4. A device according to claim 3, wherein the movement axis is parallel with or common with the rotation axis of the cosmetic article.

5. A device according to claim 1, wherein the actuation member comprises a pushing rod which extends through the support, the pushing rod comprising a first end which opens outside the casing and a second end which is connected to the return means.

6. A device according to claim 1, wherein the return means are formed by a resiliently deformable portion which is provided in a plate which abuts against an inner wall of the housing of the casing.

7. A device according to claim 1, wherein the return means comprise a resilient urging member, a spring or a resilient lug, which is interposed between the actuation member and a surface of the casing.

8. A device according to claim 1, wherein the return means are integral with one of the actuation member or the casing.

9. A device according to claim 1, wherein the urging means comprise a torsion spring which comprises a first end which is connected to the casing and a second end which is connected to the cosmetic article.

10. A device according to claim 1, wherein the cosmetic article comprises a sheath which contains a self-supporting product in the form of a baton or block, the self-supporting product being movably mounted in the sheath.

11. A device according to claim 1, wherein one of the sheath or the casing comprises a mechanism for axial deployment of the self-supporting product out of the sheath in the deployed position of the sheath.

12. A device according to claim 1, wherein the cosmetic article comprises a support which contains a cosmetic product or which carries a tool for assisting the application of a cosmetic product.

13. A device according to claim 1, further comprising releasable means for retaining the cosmetic article in the retracted position thereof counter to the urging means, the movement of the actuation member between the retention position and the release position bringing about the release of the releasable retention means.

14. A device according to claim 1, wherein a base of the housing of the casing comprises a sealing element which co-operates with the cosmetic article in the retracted position thereof.
